(19) United States
(12) Patent Application Publication
(10) Pub. No.: US 2009/0037334 A1
(43) Pub. Date: Feb. 5, 2009

(54) ELECTRONIC MEDICAL RECORD SYSTEM, METHOD FOR STORING MEDICAL RECORD DATA IN THE MEDICAL RECORD SYSTEM, AND A PORTABLE ELECTRONIC DEVICE LOADING THE ELECTRONIC MEDICAL RECORD SYSTEM THEREIN

(75) Inventors: Chien-Yeh Hsu, Yonghe (TW); Wen-Shan Jian, Taipei (TW); Hsiao-Hsien Rau, Sijhih City (TW); Te-Hui Hao, Jhonghe (TW)

Correspondence Address: LOWE HAUPTMAN HAM & BERNER, LLP, 1700 DIAGONAL ROAD, SUITE 300, ALEXANDRIA, VA, 22314, US

(73) Assignee: Taipei Medical University, Taipei (TW)

(21) Appl. No.: 12/098,516

(22) Filed: Apr. 7, 2008

(30) Foreign Application Priority Data
Aug. 1, 2007 (TW) 096128168

(51) Int. Cl. G06Q 10/00; H04L 9/00

(52) U.S. Cl. 705/51; 705/3

(57) ABSTRACT

An electronic medical record system is disclosed. The disclosed electronic medical record system comprises a data input module for receiving medical record data; a certificate module for receiving the medical record data from the data input module and processing the medical record data; a medical record data module for receiving the medical record data from the certificate module and storing the medical record data therein; and a data output module for receiving the medical record data from the certificate module and outputting the medical record data. A method for storing the medical record data into the electronic medical record system and a portable electronic device loading the electronic medical record system are also disclosed.

### RELATED APPLICATIONS

The present application is based on, and claims priority from, Taiwan Application Number 096128168, filed Aug. 1, 2007, the disclosure of which is hereby incorporated by reference herein in its entirety.

### BACKGROUND OF THE INVENTION

1. Field of the Invention

The present invention relates to an electronic medical record system, a method for storing medical record data in an electronic medical record system, and a portable electronic device loading an electronic medical record system therein, and more particularly, to such a system, a method and a device for facilitating a hospital's/clinic's loading the medical record data stored in the electronic medical record system carried by the patients, so as to assure the accuracy and the privacy of the medical record data, and to facilitate the self-management of the patients' health statuses.

2. Description of Related Art

In current medical systems, patients' medical histories exist in the paper-form and are kept in the respective hospitals/clinics. Consequently, when patients go to, or are transferred to any other hospital/clinic not previously visited, the patients' medical records have to be established again. Or, the patients need to request a summary of the respective medical history, along with related image result of the examination, from the hospitals/clinics previously attended. However, this is expensive in both time and money. Moreover, during the preparation of the summary, a significant amount of information may be omitted from the original medical record data, resulting in a lot of inconvenience to the patients.

Recently, some hospitals/clinics have improved quality of healthcare by computerizing their patients' medical records. Nevertheless, since the formats adopted for electronic medical record systems in these hospitals/clinics may vary from one to another, the adopted formats of the electronic medical record systems are incompatible with each other. Accordingly, in spite of the fact that electronic medical record systems have already been employed, patients visiting hospitals/clinics other than the previous ones are still unable to carry their electronic medical records themselves. Therefore, patients cannot use their home computers to review their medical record data, nor manage their own health statuses. In other words, although hospitals/clinics have begun using electronic medical record systems, the electronic medical record systems presently adopted still cannot overcome the problems related to inconvenient circulation of medical information, nor can the patients review their own medical records.

As described above, it is understood that there is a need for an electronic medical record system able to be carried by the patient and the medical record data stored in the electronic medical record system is able to be read by various hospitals/clinics easily. Besides, the system must be able to assure the accuracy and the privacy of the medical record data stored and enable the patients to manage their own health statuses themselves. Likewise, a method for storing the medical record data in the electronic medical record system, and a portable electronic device loading the electronic medical record system within are also required.

### SUMMARY OF THE INVENTION

An object of the present invention is to provide an electronic medical record system, so that various hospitals/clinics can access the medical record data stored in the electronic medical record systems carried by patients, so that the accuracy and the privacy of the medical record data can be assured, and the patients can manage their personal health statuses easily.

Another object of the present invention is to provide a method for storing the medical record data in the electronic medical record system, so that various hospitals/clinics can load the medical record data stored in the electronic medical record system carried by the patients and assure the accuracy without difficulty and the privacy of the medical record data.

Still another object of the present invention is to provide a portable electronic device, so that the patients can carry their personal electronic medical record systems along with them to the various hospitals/clinics, so that the executing time and the cost of the repetitive examination can be reduced. Moreover, since the electronic medical record system can store a completed and unified medical record data therein, the accuracy of the doctors' diagnoses and prescriptions can also be improved.

To achieve one of the above-mentioned objects, the electronic medical record system, according to the present invention, comprises a data input module for receiving medical record data; a certificate module for receiving the medical record data from the data input module and processing the medical record data; wherein the certificate module includes a data encrypting and decrypting unit, a certifying unit and an authorization management unit; a medical record data module for receiving the medical record data from the certificate module and storing the medical record data therein; and a data output module for receiving the medical record data from the certificate module and outputting the medical record data. Besides, the data encrypting and decrypting unit encrypts and decrypts the medical record data. The certifying unit is provided for ensuring the accuracy of the medical record data. The authorization management unit is provided to control the access to the medical record data.

To achieve another one of the objects, the method for storing a medical record data in an electronic medical record system, according to the present invention, comprises the following steps: (1) Providing the electronic medical record system including a data input module, a certificate module, a medical record data module and a data output module; wherein the certificate module includes a data encrypting and decrypting unit, a certifying unit and an authorization management unit; (2) Inputting a user's identification of the electronic medical record system and an owner's identification of the medical record data to the data input module, and transmitting the user's identification of the electronic medical record system and the owner's identification of the medical record data to the authorization management unit of the certificate module; and (3) Inputting the medical record data to the data input module, and transmitting the medical record data to the certificate module; wherein the authorization management unit of the certificate module controls whether the medical record data can or cannot be transmitted from the certificate module to the medical record data module and whether the medical record data can or cannot be stored in the medical record data module, according to the user's identification of the electronic medical record system and the owner's identification of the medical record data.

To achieve still another one of the objects, a portable electronic device, loading an electronic medical record system within, according to the present invention, comprises a data input module for receiving medical record data; a certificate module for receiving the medical record data from the data input module and processing the medical record data; wherein the certificate module includes a data encrypting and decrypting unit, a certifying unit and an authorization management unit; a medical record data module for receiving the medical record data from the certificate module and storing the medical record data therein; and a data output module for receiving the medical record data from the certificate module and outputting the medical record data. Besides, the data encrypting and decrypting unit encrypts and decrypts the medical record data, the certifying unit is provided for ensuring the accuracy of the medical record data, and the authorization management unit is provided to control the access to the medical record data.

It is understood that since the electronic medical record system according to the present invention comprises the certificate module having the data encrypting and decrypting unit, the certifying unit, and the authorization management unit, the accuracy and the privacy of the medical record data stored in the electronic medical record system can be assured. Besides, since the electronic medical record system according to the present invention further comprises an open-architecture information application module, the electronic medical record system can be easily integrated with various external application programs, such as a personal health management module, a browsing program, an editor program, and an information safety control program, the patients can manage their personal health statuses easily, through the aforementioned external application programs. On the other hand, the electronic medical record system according to the present invention still further comprises a medical record viewing and managing module having basic functions, such as editing, searching, summarizing, and outputting the medical record data. Therefore, the electronic medical record system according to the present invention can be operated individually, without the need to be operated incorporating with an extra operation system. In other words, the electronic medical record system can exist alone so that the patients can manage their health status anywhere through the electronic medical record system. Moreover, with the help of the electronic medical record system according to the present invention, various hospitals/clinics can access the medical record data stored in the electronic medical record systems carried by the patients, and consequently, there is no need for the patients to carry their paper-based medical record while being transferred to other hospitals/clinics.

Further, in the method for storing the medical record data in the electronic medical record system according to the present invention, various hospitals/clinics can load without difficulty the medical record data stored in the electronic medical record systems carried by the patients and the accuracy and the privacy of the medical record data can be assured.

To sum up, according to the present invention, through the portable electronic device loading the electronic medical record system therein, various hospitals/clinics can easily access the medical record data stored in the electronic medical record system, the accuracy and the privacy of the medical record data can be assured, and the patients can manage their health statuses on their own. Therefore, with the help of the portable electronic device according to the present invention, the patients can carry their personal electronic medical record systems along with them to the various hospitals/clinics, so that the executing time and the cost of the repetitive examination can be reduced. Moreover, since the electronic medical record systems can store completed and unified medical record data therein, the accuracy of the doctors' diagnoses and prescriptions can also be improved.

In the electronic medical record system according to the present invention, the data encrypting and decrypting unit of the certificate module may employ any kind of encrypting and decrypting method for processing encryption and decryption on the medical record data, preferably the Data Encryption Standard (DES), the International Data Encryption Algorithm (IDEA), the Advanced Encryption Standard (AES), or the RSA Encryption Algorithm. According to the present invention, the authorization management unit of the certificate module may include any number of authorization attribute values, preferably three authorization attribute values are included. In addition, the authorization attribute values may include any kind of parameter, preferably the grade of sensitivity for the medical record data, the owner's identification of the medical record data, and the user's identification permitted for accessing the medical record data are included. In the electronic medical record system according to the present invention, the authorization attribute values of the authorization management unit may each be provided with any number of code values, preferably at least two code values. In the electronic medical record system according to the present invention, the medical record data module includes a text data unit compiled by any kind of architecture, preferably by the Taiwan Electronic Medical Record Template (TMT), the Health Level 7 (HIL7), or the Clinical Document Architecture (CDA). In the electronic medical record system, the medical record data module also includes a multimedia data unit compiled by any kind of architecture, preferably by the Taiwan Electronic Medical Record Template (TMT), the Health Level 7 (HIL7), or the Clinical Document Architecture (CDA).

The method for storing the medical record data in the electronic medical record system according to the present invention may employ any kind of encrypting and decrypting method for processing encryption or decryption on the medical record data, preferably the Data Encryption Standard (DES), the International Data Encryption Algorithm (IDEA), the Advanced Encryption Standard (AES), or the RSA Encryption Algorithm. In the method for storing the medical record data in the electronic medical record system, the authorization management unit of the certificate module of the electronic medical record system includes any number of authorization attribute values, preferably three authorization attribute values are included. In addition, the authorization attribute values may include any kind of parameter, preferably the grade of sensitivity for the medical record data, the owner's identification of the medical record data, and the user's identification permitted for accessing the medical record data are included. The authorization attribute value of the authorization management unit may be provided with any number of code values, preferably at least two code values. In the method for storing the medical record data in the electronic medical record system, the medical record data module of the electronic medical record system includes a text data unit compiled by any kind of architecture, preferably by the Taiwan Electronic Medical Record Template (TMT), the Health Level 7 (HL7), or the Clinical Document Architecture (CDA). In the electronic medical record system, the medical record data module also includes a multimedia data unit compiled by any kind of architecture, preferably by the Taiwan Electronic Medical Record Template (TMT), the Health Level 7 (HL7), or the Clinic Document Architecture (CDA).

The portable electronic device loading the electronic medical record system according to the present invention can be electrically connected with any kind of display device, preferably an LCD device. In the electronic medical record system loaded in the portable electronic device, the data encrypting and decrypting unit of the certificate module may employ any kind of encrypting and decrypting method for processing encryption and decryption on the medical record data, preferably the Data Encryption Standard (DES), the International Data Encryption Algorithm (IDEA), the Advanced Encryption Standard (AES), or the RSA Encryption Algorithm. In the electronic medical record system loaded in the portable electronic device, the authorization management unit of the certificate module may include any number of authorization attribute values; preferably three authorization attribute values are included. In addition, the authorization attribute values may include any kind of parameter, preferably the grade of sensitivity of the medical record data, the owner's identification of the medical record data, and the user's identification permitted for accessing the medical record data are included. The authorization attribute value of the authorization management unit may be provided with any number of code values, preferably at least two code values. In the electronic medical record system loaded in the portable electronic device, the medical record data module includes a text data unit compiled by any kind of architecture, preferably by the Taiwan Electronic Medical Record Template (TMT), the Health Level 7 (HL7), or the Clinical Document Architecture (CDA). In the electronic medical record system loaded in the portable electronic device, the medical record data module also includes a multimedia data unit compiled by any kind of architecture, preferably by the Taiwan Electronic Medical Record Template (TMT), the Health Level 7 (HL7), or the Clinical Document Architecture (CDA). According to the present invention, the data input module of the portable electronic device may access the medical record data from any kind of data storing medium, such as a USB portable disk, a portable hard disk, a rewritable disk or an SD memory. The portable electronic device according to the present invention may include any kind of processing unit, preferably a CPU or a rule database. The portable electronic device may include any kind of memory, preferably a flash memory or a random-access memory is included. Also, the portable electronic device according to the present invention may include any kind of data output unit, preferably a serial port, a USB port, a video output port, or an IEEE 1394 port is included.

Other objects, advantages, and novel features of the present invention will become more apparent from the following detailed descriptions when taken in conjunction with the accompanying drawings.

### BRIEF DESCRIPTION OF THE DRAWINGS

The present invention is illustrated by way of example, and not by limitation, in the figures of the accompanying drawings, wherein elements having the same reference numeral designations represent like elements throughout and wherein:

FIG. 1 is a block diagram of an electronic medical record system according to the present invention.

FIG. 2 is a schematic view illustrating a certificate module of the electronic medical record system according to the present invention.

FIG. 3 is a schematic view illustrating an encrypting and a decrypting processes performed by an encrypting and decrypting unit of the certificate module of the electronic medical record system according to the present invention.

FIG. 4 is a schematic view illustrating a signature process and an authentication process performed by a certifying unit of the certificate module of the electronic medical record system according to the present invention.

FIG. 5 is a schematic view illustrating a medical record data module of the electronic medical record system according to the present invention.

FIG. 6 is a schematic view illustrating a medical record viewing and managing module of the electronic medical record system according to the present invention.

FIG. 7A is a schematic view illustrating an operational process performed by a data transmission unit of the medical record viewing and managing module of the electronic medical record system according to the present invention.

FIG. 7B is a schematic view illustrating an operational process performed by a program plug-in unit of the medical record viewing and managing module of the electronic medical record system according to the present invention.

FIG. 8 is a flow chart describing a method for storing a medical record data in the electronic medical record system according to the present invention.

FIG. 9A is a schematic view illustrating a portable electronic device loading the electronic medical record system within according to the present invention.

FIG. 9B is a block diagram illustrating an operation of the portable electronic device according to the present invention.

### DETAILED DESCRIPTION OF THE PREFERRED EMBODIMENTS

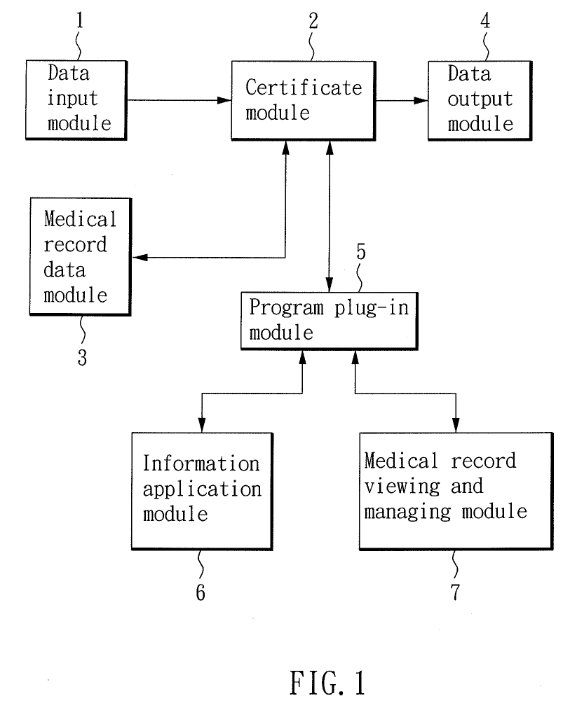

Referring to FIG. 1, an electronic medical record system according to the present invention comprises a data input module 1; a certificate module 2, a medical record data module 3 and a data output module 4; wherein the data input module 1 receives a medical record data (not shown); the certificate module 2 receives the medical record data (not shown) from the data input module 1 and processes the medical record data (not shown). The medical record data module 3 receives the medical record data (not shown) from the certificate module 2 and stores the medical record data (not shown). The data output module 4 receives the processed medical record data (not shown) from the certificate module 2 and outputs the medical record data (not shown).

As shown in FIG. 1, the electronic medical record system according to the present invention further comprises a program plug-in module 5, an information application module 6, and a medical record viewing and managing module 7; wherein the program plug-in module 5 is coupled with the certificate module 2, and the information application module 6 and the medical record viewing and managing module 7 are coupled with the program plug-in module 5, respectively. On the other hand, the information application module 6 is coupled with an external application program (not shown); wherein the external application program (not shown) can be a personal health management module, a browsing program, an editor program, or an information safety control program. Therefore, the external application program (not shown) can store the medical record data (not shown) in the medical record data module 3 and process the medical record data (not shown).

The electronic medical record system according to the present invention will be described in detail hereinafter, accompanying with each of the modules, in terms of their functions and operations.

With respect to storing a medical record data in the electronic medical record system according to the present invention:

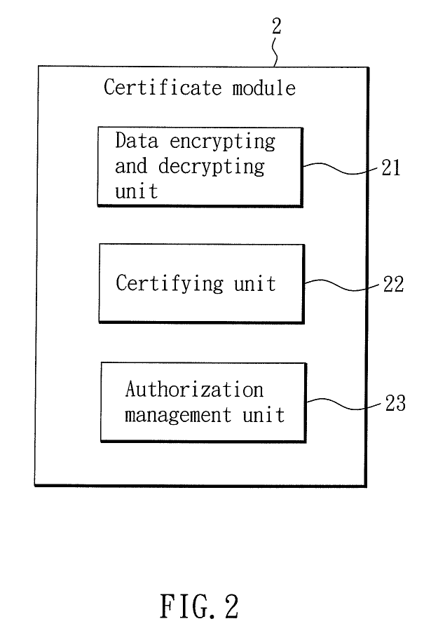

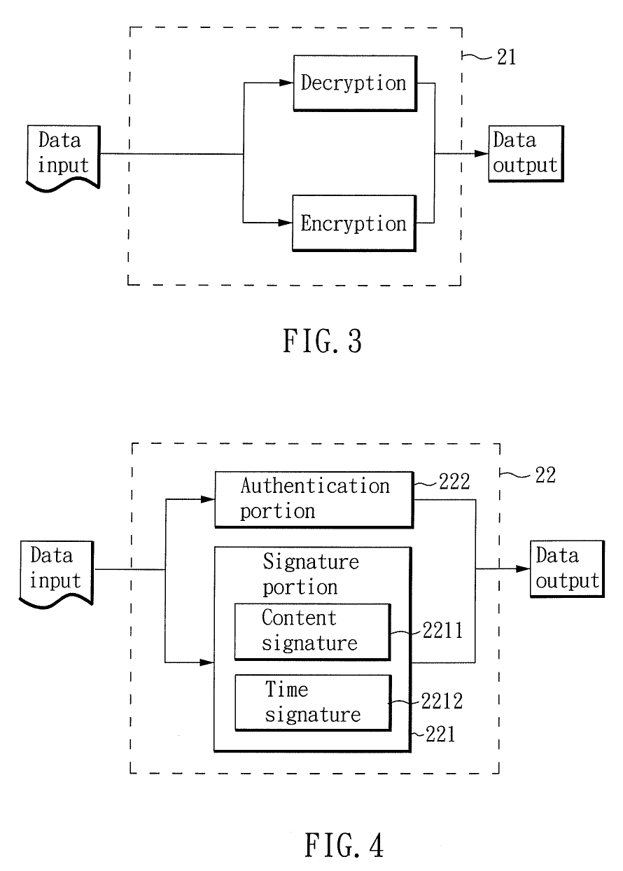

As shown in FIG. 1, after the data input module 1 has received the medical record data (not shown), the medical record data (not shown) is then transmitted to the certificate module 2, which receives and processes the medical record data (not shown). In the present invention, as shown in FIG. 2, the certificate module 2 includes a data encrypting and decrypting unit 21, a certifying unit 22 and an authorization management unit 23; wherein the data encrypting and decrypting unit 21 encrypts or decrypts the medical record data (not shown); the certifying unit 22 assures the accuracy of the medical record data (not shown), and the authorization management unit 23 controls the access to the medical record data (not shown). In the following, details will be given on the operational process of the data encrypting and decrypting unit 21, the certifying unit 22, and the authorization management unit 23, accompanying with FIGS. 3, 4 and 5.

Referring to FIG. 3, when the certificate module 2 receives the medical record data (not shown), the data encrypting and decrypting unit 21 will first determine whether the medical record data (not shown) should be proceeded with an “encrypting process” or a “decrypting process”. In general, to store medical record data (not shown) in the electronic medical record system according to the present invention, the process required for the data encrypting and decrypting unit 21 is “encryption,” i.e. to encrypt the medical record data (not shown). In this respect, the data encrypting and encrypting unit 21 employs the Advanced Encryption Standard (AES) to encrypt the medical record data (not shown), so that the medical record data (not shown) are converted from the Plaintext” to the “Ciphertext”. As long as the encrypting process is finished, the data encrypting and decrypting unit 21 outputs the “Ciphertext” to the certifying unit 22. As a result, once the process “encrypting” is completed, the “privacy” of the medical record data (not shown) can be assured.

In contrast, when accessing the medical record data (not shown) from the electronic medical record system according to the present invention, i.e. to read the medical record data (not shown), the data encrypting and decrypting unit 21 will decrypt the medical record data (not shown). In other words, the AES is employed to decrypt the medical record data (not shown) so as to convert the “Ciphertext” into the “Plaintext”, then the data encrypting and decrypting unit 21 outputs the “Plaintext”.

When the certifying unit 22 receives the medical record data (not 5 shown) which have been converted into the “Plaintext”, the certifying unit proceeds with a “certifying process” so as to assure the “accuracy” of the medical record data (not shown). The certifying process is described in detail as follows (see FIG. 4):

The certifying unit 22 of the certificate module 2 in the electronic medical record system according to the present invention includes a signature portion 221 and an authentication portion 222, both of them adopting the Hash Function for their operation. When the certifying unit 22 receives the medical record data (not shown), the certifying unit 22 will first determine whether the medical record data (not shown) should be proceeded with a “signature process” or an “authentication process.” In general, to store the medical record data (not shown) in the electronic medical record system according to the present invention, the process required for the certifying unit 22 is the “signature process,” i.e. to proceed with a signature process on the medical record data (not shown). In this respect, the signature portion 221 processes the medical record data (not shown) with a one-way Hash Function, so as to produce a corresponding “Message Digest” (i.e. the result of Hash function). Thereafter, the signature portion 221 makes use of a user's private key of the electronic medical record system to proceed with a signature process on the Hash Result, so as to produce a “signature data” on the medical record data (not shown). In other words, the “signature data” produced from the aforementioned signature process has an unique property for the medical record data and the user. Moreover, in case the medical record data (not shown) have been modified, the “signature data” produced correspondingly from the aforementioned signature process will be changed. Such a change can be uncovered through a following “authentication” process. As a result, so long as the signature portion 221 of the certifying unit 22 has finished the aforementioned “signature process”, the “accuracy” and the “undeniability” of the medical record data (not shown) can be assured.

On the other hand, the aforementioned signature portion 221 includes a content signature 2211 provided for assuring the accuracy of the medical record data (not shown), and a time signature 2212 for indicating the modification time of the medical record data (not shown). Besides, once the medical record data (not shown) has been modified, the “content signature 2211” and the “time signature 2212” will become void simultaneously, so as to alert the user that the medical record data (not shown) has been modified.

In contrast, while accessing the medical record data (not shown) from the electronic medical record system according to the present invention, i.e. reading the medical record data (not shown), in order to assure the “accuracy” and “undeniability” of the medical record data (not shown), the authentication portion 222 of the certifying unit 22 will proceed with an authentication on the medical record data (not shown). Namely, a public key may be used for proceeding the authentication process on the signatured medical record data (not shown), so as to identify whether the medical record data (not shown) has been modified, and whether the owner of the medical record data (not shown) is the patient himself/herself. After the authentication process has been executed by the certifying unit 22, the medical record data (not shown) are then transmitted to, and stored in, the medical record data module 3. The medical record data (not shown) can only be stored in, and accessed from the medical record data module 3 by authorized persons, such as the doctors or the nurses, so as to prevent the medical record data (not shown) from any kind of unauthorized use. In the electronic medical record system of the present invention, the authorization management unit 23 of the certificate module 2 controls whether the medical record data (not shown) can be transmitted from the certificate module 2 to, and stored in, the medical record data module 3, and whether the medical record data (not shown) can be accessed from the medical record data module 3, according to the user's identification of the electronic medical record system and owner's identification of the medical record data. Details will be given as follows for the operation of the authorization management unit 23:

In the present invention, the authorization management unit 23 relates to a multi-layer authorization architecture. In other words, the authorization management unit 23 has multi-dimensional authorizations. In the present invention, the authorization management unit 23 is operated in such a manner that three authorization attribute values are added at the beginning of the medical record data (not shown), including the grade of sensitivity, the identification of the owner of the medical record data (not shown), and the identification of the user permitted for accessing the medical record data (not shown). Besides, each of the three authorization attribute values has four code values.

After arrangement, in the electronic medical record system according to the present invention, the authorization management unit 23 of the certificate module 2 uses an authorization architecture shown in the

“Code Set” of the following Table 1:

TABLE 1

| Authorization Attribute Values | Code Values |
|---|---|
| 1. Grade of Sensitivity of the Medical | 1. Extremely High 2. High |
| Record Data | 3. Fair 4. Low |
| 2. Owner's Identification of the | 1. Senior Officials 2. Official |
| Medical Record Data | 3. Healthcare Personal 4. General |
| 3. User's Identification Permitted for | 1. Doctors 2. Nurses 3. Medical |
| Accessing the Medical Record | Administrators 4. Patients |
| Data | |

In the Code Set of Table 1, the code values of each of the authorization attribute values are provided for determining whether the user of the electronic medical record system according to the present invention has the authorization of accessing or editing the medical record data (not shown), so as to make sure that the medical record data (not shown) is used legitimately.

For example, when the electronic medical record system according to the present invention stores a senior official's medical record data therein, the authorization management unit 23 will assign, among the authorization attribute values, the grade of sensitivity of the medical record data as “1” and the owner's identification of the medical record data as “1” and the user's identification permitted for accessing the medical record data as “1”. Consequently, only the doctors can access and edit this senior official's medical record data stored in the electronic medical record system according to the present invention.

Further, if the authorization management unit 23 assigns, among the authorization attribute values, the “user's identification permitted for accessing the medical record data” as “1 and 4”, then only the “doctors” and the “patients” themselves can access and edit the medical record data. Other healthcare personal, such as the nurses and the administrators, can access the medical record data, but they cannot edit the medical record data.

As mentioned above, the patients can edit and access the medical record data. However, in the case of the patients themselves having modified the medical record data, the doctors can still notice that the medical record data has been modified, during the reading process of the medical record data, through the aforementioned “authentication process” executed by the certifying unit 22. As a result, there is no need to be worried that the doctors would erroneously diagnose and prescriptions according to the medical record data modified by the patients.

From the above description, it is understood that only authorized 25 personal, such as the doctors or the nurses, under the control of the authorization management unit 23, can store the medical record data in the medical record data module 3 of the electronic medical record system according to the present invention. Details will be given as follows for the composition of the medical record data module 3:

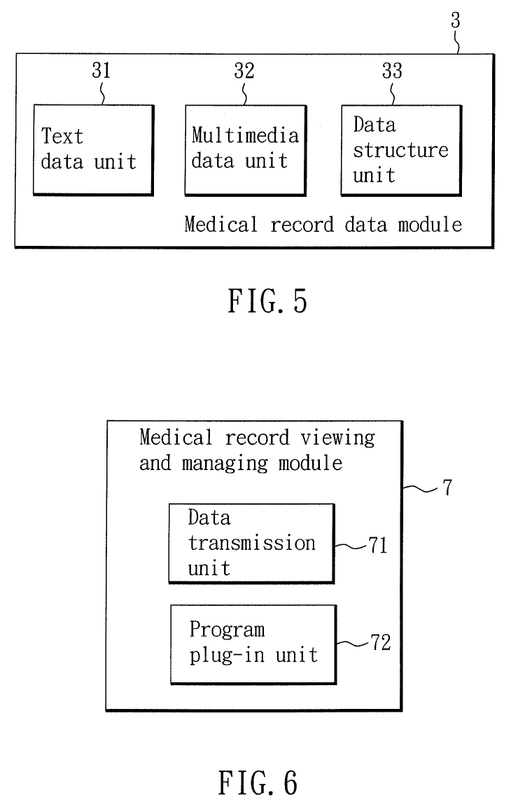

As shown in FIG. 5, the medical record data module 3 of the electronic medical record system according to the present invention includes a text data unit 31, a multimedia data unit 32, and a data structure unit 33; wherein both the text data unit 31 and the multimedia data unit 32 are compiled with the Taiwan Electronic Medical Record Template (TMT). The TMT applies the form of label which the medical record data stored in the medical record data module 3, is compiled into a plurality of files in the XML format, wherein the XML-format files are established as a tree-like file architecture. Therefore, the searching process of the XML-format files carried the medical record data can be simplified.

In addition, the text data unit 31 may include documents such as basic data, clinic data, medical record descriptions, allergy history, medicine records, surgery history, expatriate history, subjective, objective, assessment, and plan. The multimedia data unit 32 may include X-ray films, Computerized Tomography Scan (CT) image data, Magnetic Resonance Imaging (Mifi) image data, sound recording file (Electrocardiogram heart sounds), and video files (videos of patients' walking). The data structure unit 33 is to define the “data structure” and the “data form” of the medical record data stored in the medical record data module 3 of the electronic medical record system according to the present invention, so that the medical record data can be searched and accessed easily. As a result, so long as the medical record data are stored in the medical record data module 3, the data storing process is completed.

The process for accessing the medical record data from the medical record data module 3 is described as follows:

First, the data input module of the electronic medical record system according to the present invention receives the user's identification of the electronic medical record system and the owner's identification of the medical record data, and transmits them to the authorization management unit 23 of the certificate module 2, wherein the authorization management unit 23 determines whether the user has been authorized to access the medical record data stored in the medical record data module 3, according to the user's identification of the electronic medical record system and the owner's identification of the medical record data.

In the case which the user has been authorized to access the medical record data, the medical record data will be transmitted to the certificate module 2, wherein the certifying unit 22 of the certificate module 2 executes an “authentication process” for verifying whether the medical record data have been modified, and if the medical record data indeed been modified, the certifying unit 22 submits an alert message to the user. In contrast, if the “authentication process” indicates that the medical record data has not been modified, then the medical record data is transmitted to the data encrypting and decrypting unit 21 of the certificate module 2, wherein the medical record data in a “Ciphertext” is decoded and converted into an “Plaintext”. Finally, the medical record data in the “Plaintext” is transmitted to the data output module 4 of the electronic medical record system according to the present invention and then transmitted to the outside.

Further referring to FIG. 1, in addition to the data input module 1, the certificate module 2, the medical record data module 3 and the data output module 4, the electronic medical record system according to the present invention further comprises a program plug-in module 5, an information application module 6, and a medical record viewing and managing module 7. The information application module 6 and the medical record viewing and managing module 7 are coupled with the program plug-in module 5, respectively. The program plug-in module 5 is coupled with the certificate module 2. That is to say, the program plug-in module 5 provides a coupling channel, thereby the information application module 6 and the medical record viewing and managing module 7 can access the medical record data stored in the medical record data module 3. The operation of the information application module 6 and the medical record viewing and managing module 7 is described as follows:

In the present invention, the information application module 6 is coupled with external application programs, such as a health examination data management system, a body weight control and reduction system, or an X-ray viewing system. To this effect, the information application module is provided for managing the external application programs and storing these programs within. On the other hand, since the information application module 6 has an open program coding architecture, the external application programs written by anyone can be easily operated within the information application module 6, and read the medical record data stored in the medical record data module 3.

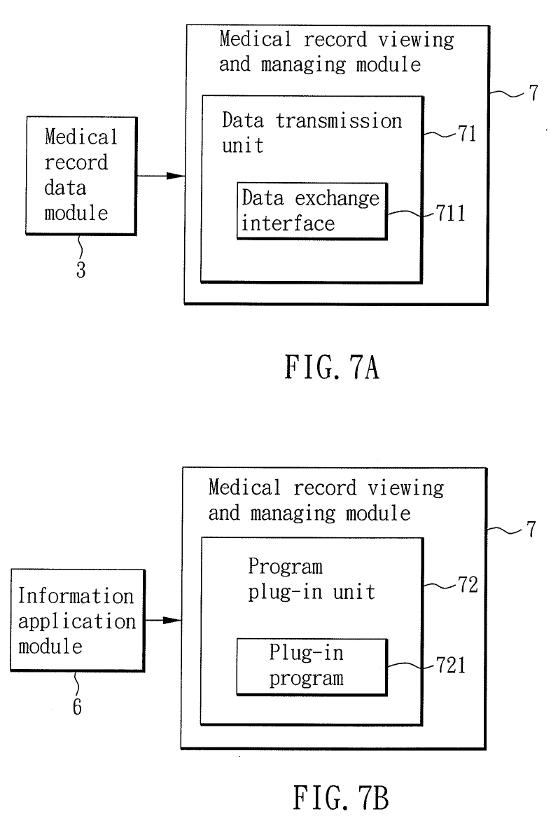

Further, in the present invention, the medical record viewing and managing module 7 is provided for accessing the medical record data stored in the medical record data module 3, and processing and applying the medical record data. As shown in FIG. 6, the medical record viewing and managing module 7 includes a data transmission unit 71 and a program plug-in unit 72; wherein the data transmission unit 71 is coupled with the medical record data module 3, through the program plug-in module 5 and the certificate module 2, as shown in FIG. 7A. The data transmission unit 71 includes a data exchange interface 711, so as to access the medical record data stored in the medical record data module 3, as required by an application of the medical record viewing and managing module 7. Further, as shown in FIG. 7B, the program plug-in unit 72 includes a plug-in program 721 and is coupled with the information application module 6, through the plug-in module S. Therefore, the external application program stored in the information application module 6 can be integrated with the medical record viewing and managing module 7.

In the present invention, since both the text data unit 31 and the multimedia data unit 32 of the medical record data module 3 are compiled with the TMT, as mentioned above, the medical record viewing and managing module 7 can analyze (or PASER) the XML-format files compiled from the medical record data. In addition, the medical record viewing and managing module 7 can display the result of the analysis on a user's interface module (not shown). As a result, the user can through the user's interface module, edit, search, summarize, and output the relevant medical record data; while the medical record viewing and managing module 7 can, in the meantime, produce a related statistics graph for the user's search and management purpose.

As described above, it is understood that various hospitals/clinics can easily access the medical record data stored in the electronic medical record system according to the present invention, wherein the accuracy and the privacy of the medical record data can be assured. Consequently, there is no need for the patients to carry their paper-based medical records while being transferred to other hospitals/clinics.

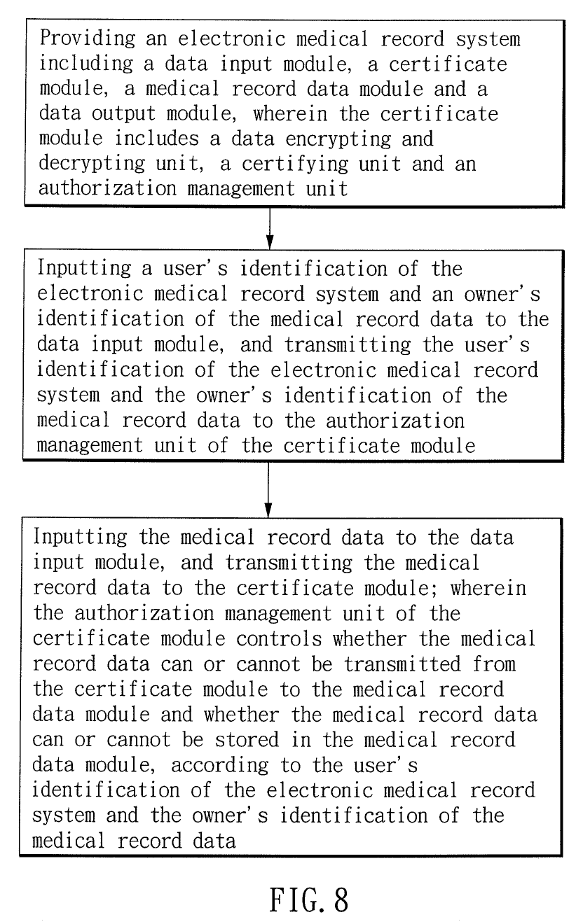

Now referring to FIG. 8, a flow chart describing a method for storing the medical record data in the electronic medical record system according to the present invention is shown, wherein the method comprises the following steps:

Step S1: Providing the electronic medical record system including a data input module, a certificate module, a medical record data module and a data output module; wherein the certificate module includes a data encrypting and decrypting unit, a certifying unit and an authorization management unit;

Step S2: Inputting a user's identification of the electronic medical record system and an owner's identification of the medical record data to the data input module, and transmitting the user's identification of the electronic medical record system and the owner's identification of the medical record data to the authorization management unit of the certificate module; and

Step S3: Inputting the medical record data to the data input module, and transmitting the medical record data to the certificate module; wherein the authorization management unit of the certificate module controls whether the medical record data can or cannot be transmitted from the certificate module to the medical record data module and whether the medical record data can or cannot be stored in the medical record data module, according to the user's identification of the electronic medical record system and the owner's identification of the medical record data.

Therefore, after the user's identification of the electronic medical record system and the owner's identification of the medical record data have been transmitted to the authorization management unit of the certificate module, the authorization management unit determines whether the medical record data can be stored in the medical record data module based on an authorization given to the user. In the meantime, the authorization management unit of the certificate module assigns an authorization attribute value to the medical record data, such as the grade of sensitivity of the medical record data, the owner's identification of the medical record data, and the user's identification permitted for accessing the medical record data, so as to control the access to the medical record data.

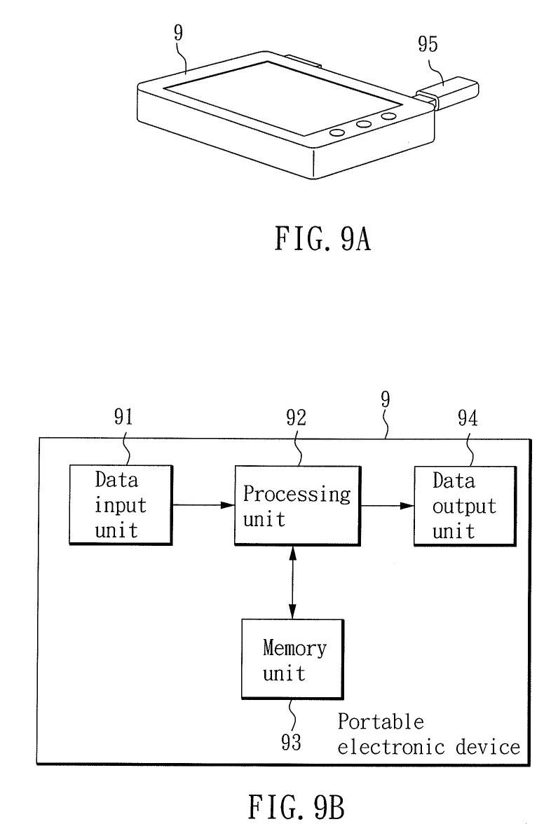

Referring to FIG. 9A, a schematic view illustrating a portable electronic device 9 loading the electronic medical record system within according to the present invention is shown. In FIG. 9B, a block diagram illustrating operation of the portable electronic device 9 is shown. The electronic medical record system, as mentioned above, includes the data input module for receiving the medical record data; the certificate module for receiving the medical record data from the data input module and processing the medical record data, wherein the certificate module includes the data encrypting and decrypting unit, the certifying unit and the authorization management unit; the medical record data module for receiving the medical record data from the certificate module and for storing the medical record data; and the data output module for receiving the medical record data from the certificate module and for outputting the medical record data. The data encrypting and decrypting unit encrypts and decrypts the medical record data. The certifying unit is provided for ensuring the accuracy of the medical record data, and the authorization management unit is provided for controlling the access to the medical record data.

As shown in FIG. 9B, the portable electronic device 9 comprises a data input unit 91, a processing unit 92, a memory unit 93, and a data output unit 94; wherein the data input module of the electronic medical record system described above, is operated in the input unit 91, the certificate module and the medical record data module are stored in the memory unit 93, and the data output module is operated in the data output unit 94.

Further, the process required by the certificate module in the encryption or decryption procedure, the certifying procedure and the authorization management procedure are performed in the processing unit 92; and the processing data required for performing the aforementioned encrypting or decrypting procedure, the certifying procedure, and the authorization management procedure, such as the public key, the private key, the encrypting algorithm, the decrypting algorithm, and the signature algorithm and the authentication algorithm are stored in the memory unit 93.

Still further, in the present invention, the portable electronic device 9 may be a Personal Digital Assistant (PDA), wherein the data input unit 91 is a USB port and the medical record data can be accessed from a USB portable disk 95. Besides, the processing unit 92 is a CPU, the memory unit 93 is a flash memory, and the data output unit 94 is an image output port connected with an LCD device (not shown).

The portable electronic device 9 has the electronic medical record 10 system loaded within, as mentioned above. As a result, there is no need to redundantly describe as how the data input module 1, the certificate module 2, the medical record data module 3 and the data output module 4 are operated.

With the help of the portable electronic device 9 according to the present invention, patients can carry their personal electronic medical record systems themselves to various hospitals/clinics, so that the executing time and the cost of the repetitive examination can be saved. Moreover, since the electronic medical record systems can store completed and unified medical record data therein, the accuracy of the doctors' diagnosis and prescription can also be improved.

In summary, it is understood that since the electronic medical record system according to the present invention comprises the certificate module having the data encrypting and decrypting unit, the certifying unit, and the authorization management unit, the accuracy and the privacy of the medical record data stored in the electronic medical record system can be assured. Besides, since the electronic medical record system according to the present invention further comprises an open-architecture information application module, the electronic medical record system can be easily integrated with various external application programs, such as a personal health management module, a browsing program, an editor program, and an information safety control program, the patients can manage their personal health statuses easily, through the aforementioned external application programs. The electronic medical record system according to the present invention still further comprises a medical record viewing and managing module having basic functions, such as editing, searching, summarizing, and outputting the medical record data. Therefore, the electronic medical record system according to the present invention can be operated individually, without the need to be operated incorporating with an extra operation systems. In other words, the electronic medical record system can exist alone so that the patients can manage their health statuses anywhere through the electronic medical record system. Moreover, with the help of the electronic medical record system according to the present invention, various hospitals/clinics can access the medical record data stored in the electronic medical record systems carried by the patients, and consequently, there is no need for the patients to carry their paper-based medical record while being transferred to other hospitals/clinics.

Further, in the method for storing the medical record data in the electronic medical record system according to the present invention, various hospitals/clinics can load the medical record data stored in the electronic medical record systems carried by the patients without difficulty and the accuracy and the privacy of the medical record data can be assured.

To sum up, according to the present invention, through the portable electronic device loading the electronic medical record system therein, various hospitals/clinics can easily access the medical record data stored in the electronic medical record system, the accuracy and the privacy of the medical record data can be assured, and the patients can manage their health statuses on their own. Therefore, with the help of the portable electronic device according to the present invention, the patients can carry their personal electronic medical record systems along with them to the various hospitals/clinics, so that the executing time and the cost of the repetitive examination can be reduced. Moreover, since the electronic medical record systems can store completed and unified medical record data therein, the accuracy of the doctors' diagnoses and prescriptions can also be improved.

Although the present invention has been explained in relation to its preferred embodiments, it is to be understood that many other possible modifications and variations can be made without departing from the scope of the invention as hereinafter claimed.

What is claimed is:

1. An electronic medical record system, comprising:
a data input module, for receiving medical record data;
a certificate module, for receiving the medical record data from the data input module and processing the medical record data; wherein the certificate module includes a data encrypting and decrypting unit, a certifying unit and an authorization management unit;
a medical record data module, for receiving the medical record data from the certificate module and storing the medical record data therein; and
a data output module, for receiving the medical record data from the certificate module and outputting the medical record data;
wherein the data encrypting and decrypting unit encrypts and decrypts the medical record data, the certifying unit is provided for ensuring the accuracy of the medical record data, and the authorization management unit is provided to control the access to the medical record data.

2. The electronic medical record system as claimed in claim 1, wherein the data encrypting and decrypting unit encrypts or decrypts the medical record data with the Advanced Encryption Standard.

3. The electronic medical record system as claimed in claim 1, wherein the certifying unit includes a signature portion and an authentication portion.

4. The electronic medical record system as claimed in claim 3, wherein the signature portion includes a content signature for assuring the accuracy of the medical record data, and a time signature for indicating the time of the modification to the medical record data.

5. The electronic medical record system as claimed in claim 1, wherein the authorization management unit has three kinds of authorization attribute values, including the grade of sensitivity of the medical record data, the owner's identification of the medical record data, and the user's identification permitted for accessing the medical record data.

6. The electronic medical record system as claimed in claim 5, wherein each of the three kinds of authorization attribute values has plural code values.

7. The electronic medical record system as claimed in claim 1, wherein the medical record data module includes a text data unit, a multimedia data unit, and a data structure unit.

8. The electronic medical record system as claimed in claim 7, wherein the text data unit is compiled with the Taiwan Electronic Medical Record Template.

9. The electronic medical record system as claimed in claim 7, wherein the multimedia data unit is compiled with the Taiwan Electronic Medical Record Template.

10. The electronic medical record system as claimed in claim 1, further comprising a program plug-in module coupled with the certificate module.

11. The electronic medical record system as claimed in claim 10, further comprising an information application module coupled with the program plug-in module.

12. The electronic medical record system as claimed in claim 11, wherein the information application module is coupled with an external application program so as to access the medical record data.

13. The electronic medical record system as claimed in claim 11, further comprising a medical record viewing and managing module including a data transmission unit and a program plug-in unit.

14. The electronic medical record system as claimed in claim 13, wherein the data transmission unit is coupled with the medical record data module so as to access the medical record data.

15. The electronic medical record system as claimed in claim 13, wherein the program plug-in unit is coupled with the information application module so as to access the medical record data.

16. A method for storing medical record data in an electronic medical record system, comprising the following steps:
providing the electronic medical record system including a data input module, a certificate module, a medical record data module and a data output module; wherein the certificate module includes a data encrypting and decrypting unit, a certifying unit and an authorization management unit;
inputting a user's identification of the electronic medical record system and an owner's identification of the medical record data to the data input module, and transmitting the user's identification of the electronic medical record system and the owner's identification of the medical record data to the authorization management unit of the certificate module; and
inputting the medical record data to the data input module, and transmitting the medical record data to the certificate module;
wherein the authorization management unit of the certificate module controls whether the medical record data can or cannot be transmitted from the certificate module to the medical record data module and whether the medical record data can or Cannot be stored in the medical record data module, according to the user's identification of the electronic medical record system and the owner's identification of the medical record data.

17. The method as claimed in claim 16, wherein after the medical record data being transmitted to the certificate module, the data encrypting and decrypting unit of the certificate module encrypts the medical record data.

18. The method as claimed in claim 17, wherein the data encrypting and encrypting unit encrypts the medical record data with the Advanced Encryption Standard.

19. The method as claimed in claim 16, wherein after the medical record data being transmitted to the certificate module, the certifying unit of the certificate module signing the medical record data.

20. The method as claimed in claim 16, wherein the authorization management unit has three kinds of authorization attribute values, including grade of sensitivity of the medical record data, the owner's identification of the medical record data, and the user's identification permitted for accessing the medical record data.

21. The method as claimed in claim 20, wherein each of the three kinds of authorization attribute values has plural code values.

22. The method as claimed in claim 16, wherein the medical record data module includes a text data unit, a multimedia data unit, and a data structure unit.

23. The method as claimed in claim 22, wherein the text data unit is compiled with the Taiwan Electronic Medical Record Template.

24. The method as claimed in claim 22, wherein the multimedia data unit is compiled with the Taiwan Electronic Medical Record Template.

25. A portable electronic device, loading an electronic medical record system within, the electrical record system comprising:
a data input module, for receiving medical record data;
a certificate module, for receiving the medical record data from the data input module and processing the medical record data; wherein the certificate module includes a data encrypting and decrypting unit, a certifying unit and an authorization management unit;
a medical record data module, for receiving the medical record data from the certificate module and storing the medical record data therein; and
a data output module, for receiving the medical record data from the certificate module and outputting the medical record data;
wherein the data encrypting and decrypting unit encrypts and decrypts the medical record data, the certifying unit is provided for ensuring the accuracy of the medical record data, and the authorization management unit is provided to control the access to the medical record data.

26. The portable electronic device as claimed in claim 25, wherein the portable electronic device is electrically connected with a display device.

27. The portable electronic device as claimed in claim 26, wherein the display device is an LCD device.

28. The portable electronic device as claimed in claim 25, wherein the data encrypting and decrypting unit of the electronic medical record system encrypts or decrypts the medical record data with the Advanced Encryption Standard.

29. The portable electronic device as claimed in claim 25, wherein the certifying unit of the certificate module of the electronic record system includes a signature portion and an authentication portion.

30. The portable electronic device as claimed in claim 29, wherein the signature portion includes a content signature for assuring the accuracy of the medical record data, and a time signature for indicating the time of the modification time to the medical record data.

31. The portable electronic device as claimed in claim 25, wherein the authorization management unit of the certificate module of the electronic medical record system has three kinds of authorization attribute values, including grade of sensitivity of the medical record data, the owner's identification of the medical record data, and the user's identification permitted for accessing the medical record data.

32. The portable electronic device as claimed in claim 31, wherein each of the three kinds of authorization attribute values has plural code values.

33. The portable electronic device as claimed in claim 25, wherein the medical record data module includes a text data unit, a multimedia data unit, and a data structure unit.

34. The portable electronic device as claimed in claim 33, wherein the text data unit is compiled with the Taiwan Electronic Medical Record Template.

35. The portable electronic device as claimed in claim 33, wherein the multimedia data unit is compiled with the Taiwan Electronic Medical Record Template.

36. The portable electronic device as claimed in claim 25, wherein the electronic medical record system further comprises a program plug-in module coupled with the certificate module.

37. The portable electronic device as claimed in claim 36, wherein the electronic medical record system further comprises an information application module coupled with the program plug-in module.

38. The portable electronic device as claimed in claim 37, wherein the information application module is coupled with an external application program so as to access the medical record data.

39. The portable electronic device as claimed in claim 37, wherein the electronic medical record system further comprises a medical record viewing and managing module including a data transmission unit and a program plug-in unit.

40. The portable electronic device as claimed in claim 39, wherein the data transmission unit is coupled with the medical record data module so as to access the medical record data.

41. The portable electronic device as claimed in claim 39, wherein the program plug-in unit is coupled with the information application module so as to access the medical record data.

42. The portable electronic device as claimed in claim 25, wherein the data input module of the electronic medical record system is operated in a data input unit of the portable electronic device.

43. The portable electronic device as claimed in claim 42, wherein the data input unit accesses the medical record data from a portable disk.

44. The portable electronic device as claimed in claim 25, wherein the certificate module and the medical record data module of the electronic medical record system are stored in a memory unit of the portable electronic device.

45. The portable electronic device as claimed in claim 25, wherein the processing procedures required by the certificate module of the electronic medical record system during the encrypting procedure, the decrypting procedure, the certifying procedure, and the authorization managing procedure are performed in a processing unit of the portable electronic device.

46. The portable electronic device as claimed in claim 25, wherein the data output module of the electronic medical record system is operated in a data output unit of the portable electronic device.

47. The portable electronic device as claimed in claim 46, wherein the data output unit of the portable electronic device is an image output port.
